(19) United States
(12) Patent Application Publication
(10) Pub. No.: US 2025/0009170 A1
(43) Pub. Date: Jan. 9, 2025

(54) ADJUSTABLE CLAMPING AND GRATE SYSTEM FOR COOKING DEVICES

(71) Applicant: Norman Yoder, Shipshewana, IN (US)

(72) Inventor: Norman Yoder, Shipshewana, IN (US)

(21) Appl. No.: 18/346,517

(22) Filed: Jul. 3, 2023

(51) Int. Cl. A47J 37/04

(52) U.S. Cl. CPC A47J 37/041

(57) ABSTRACT

A cooking device includes a clamping and grate system including: a clamp with a lever movable between an open position and a closed position and a clamp body having a clamp mounting feature and configured to move responsively to the lever moving between the positions; a first grate; a second grate adjustably spaced from the first grate; and a spring assembly including a spring configured to exert a biasing force on the second grate towards the first grate and an adjustment block including adjustment features. One of the adjustment features is coupled to the clamp mounting feature and the plurality of adjustment features are each configured to reversibly couple with the clamp mounting feature such that a distance between the spring and the first grate is controlled by which one of the adjustment features is coupled with the clamp mounting feature when the lever is in the closed position.

### BACKGROUND OF THE INVENTION

### 1. Field of the Invention

The present invention relates to cooking devices, and, more particularly, to clamps and grates for cooking devices.

### 2. Description of the Related Art

Many types of cooking devices are known. One type of cooking device is known as a rotisserie and rotates food items in a cooking chamber to evenly cook the food items. The heat source may be, for example, flammable solid material such as wood and/or charcoal or, alternatively, an electric coil and/or a gas burner.

Regardless of the heat source used, the food items are generally held out of direct contact with the heat source to avoid burning the food. Holders for the food items may include grates and/or baskets that rotate within the cooking chamber and hold the food. For example, a pair of grates may be provided that hold food items between the grates and are commonly known as “sandwich grates” because the food items are sandwiched between the grates. While such grates effective for holding food, it is difficult to adjust the grates to accommodate differently sized food items.

What is needed in the art is a way to hold a variety of differently sized food items for cooking in a cooking device.

### SUMMARY OF THE INVENTION

The present invention provides a cooking device with a clamping and grate system that has a spring assembly with a plurality of adjustment features that control a distance between a spring and a grate.

The invention in one form is directed to a cooking device including a cooking chamber and at least one clamping and grate system disposed inside the cooking chamber. The at least one clamping and grate system includes: a clamp including a lever that is movable between an open position and a closed position and a clamp body having a clamp mounting feature and configured to move responsively to the lever moving between the open position and the closed position; a first grate; a second grate adjustably spaced from the first grate; and a spring assembly including a spring configured to exert a biasing force on the second grate towards the first grate and an adjustment block having a plurality of adjustment features. One of the adjustment features is coupled to the clamp mounting feature and the plurality of adjustment features are each configured to reversibly couple with the clamp mounting feature such that a distance between the spring and the first grate is controlled by which one of the adjustment features is coupled with the clamp mounting feature when the lever is in the closed position.

The invention in another form is directed to a clamping and grate system including a clamp including a lever that is movable between an open position and a closed position and a clamp body having a clamp mounting feature and configured to move responsively to the lever moving between the open position and the closed position; a first grate; a second grate adjustably spaced from the first grate; and a spring assembly including a spring configured to exert a biasing force on the second grate towards the first grate and an adjustment block having a plurality of adjustment features. One of the adjustment features is coupled to the clamp mounting feature and the plurality of adjustment features are each configured to reversibly couple with the clamp mounting feature such that a distance between the spring and the first grate is controlled by which one of the adjustment features is coupled with the clamp mounting feature when the lever is in the closed position.

One possible advantage of the present invention is that a minimum spacing between the grates can be easily adjusted by changing which one of the adjustment features is coupled to the clamp mounting feature.

Another possible advantage is the grates can be held in the cooking device such that cooking food items self-baste with reduced liquid loss.

Yet another possible advantage is the clamping and grate system can be easily retrofit to an existing cooking device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a sectional view of a cooking device that includes a plurality of clamping and grate systems provided according to the present invention;

FIG. 2 is a sectional view of the cooking device of FIG. 1 after the clamping and grate systems have been rotated by a rotator of the cooking device;

FIG. 3 is a side view of one of the clamping and grate systems illustrated in FIGS. 1-2 with a clamp having a lever in an open position;

FIG. 4A is a side view of one of the clamping and grate systems illustrated in FIGS. 1-3 with the lever in a closed position and an adjustment feature of an adjustment block coupled to a clamp mounting feature of the clamp;

FIG. 4B is a side view of the clamping and grate system illustrated in FIG. 4A with the lever in the closed position and another one of the adjustment features of the adjustment block coupled to the clamp mounting feature;

FIG. 4C is a side view of the clamping and grate system illustrated in FIGS. 4A-4B with the lever in the closed position and yet another one of the adjustment features of the adjustment block coupled to the clamp mounting feature;

FIG. 5A is a close-up side view of the clamp illustrated in FIGS. 1-4C in the open position;

FIG. 5B is a close-up side view of the clamp illustrated in FIGS. 1-5A in the closed position; and

FIG. 6 is a sectional view of the cooking device of FIGS. 1-2 with a basket carried by the rotator.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

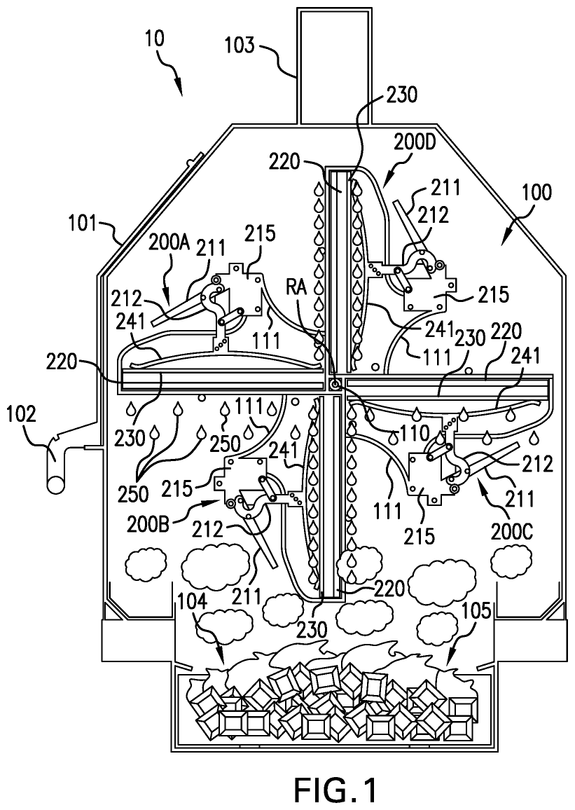

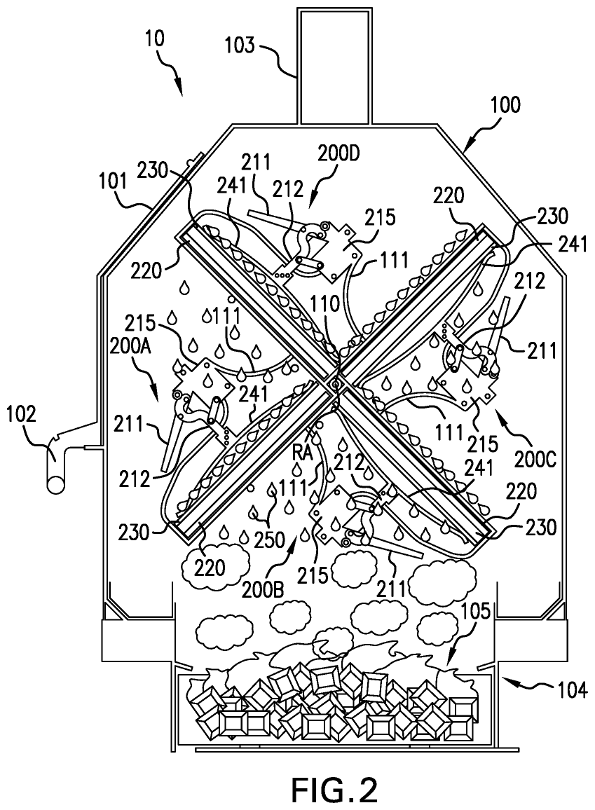

Referring now to the drawings, and more particularly to FIGS. 1 and 2, there is shown an exemplary embodiment of a cooking device 10 which generally includes a cooking chamber 100 and at least one clamping and grate system, illustrated as four clamping and grate systems 200A, 200B, 200C, 200D, disposed in the cooking chamber 100. A lid 101 may be coupled to the cooking chamber 100 and a user may grasp a handle 102 coupled to the lid 101 in order to open and close the cooking chamber 100, as is known. The cooking chamber 100 may also include a chimney 103 to exhaust heat from the cooking chamber 100. Any suitable shape and material may be used to form the cooking chamber 100, with many such shapes and materials being known.

In some embodiments, the systems 200A, 200B, 200C, 200D are each coupled to a rotator 110 disposed within the cooking chamber 100 that is configured to rotate within the cooking chamber 100. Each of the systems 200A, 200B, 200C, 200D may, for example, be bolted to a respective sheet 111 that is coupled to the rotator 110. When the systems 200A, 200B, 200C, 200D are coupled to the rotator 110, rotation of the rotator 110 causes the coupled systems 200A, 200B, 200C, 200D to rotate about a rotation axis RA, the significance of which will be described further herein. The cooking chamber 100 may also include a firebox 104 that can be a heat source for cooking food items within the cooking chamber 100. The firebox 104 may, for example, be configured to hold, and in some embodiments also ignite, solid combustible material 105 such as wood and/or charcoal. The rotator 110 may be configured to rotate the coupled systems 200A, 200B, 200C, 200D over the firebox 104 so food items held by one or more of the coupled systems 200A, 200B, 200C, 200D cook from heat originating at the firebox 104. It should be appreciated that while the cooking chamber 100 is described and illustrated as including a firebox 104 as the heat source, other heat sources may be provided in the cooking chamber 100 including but not limited to electric coils and/or gas burners. It should thus be appreciated that the heat source utilized in the cooking device 10 provided according to the present invention may be a variety of different types of heat sources.

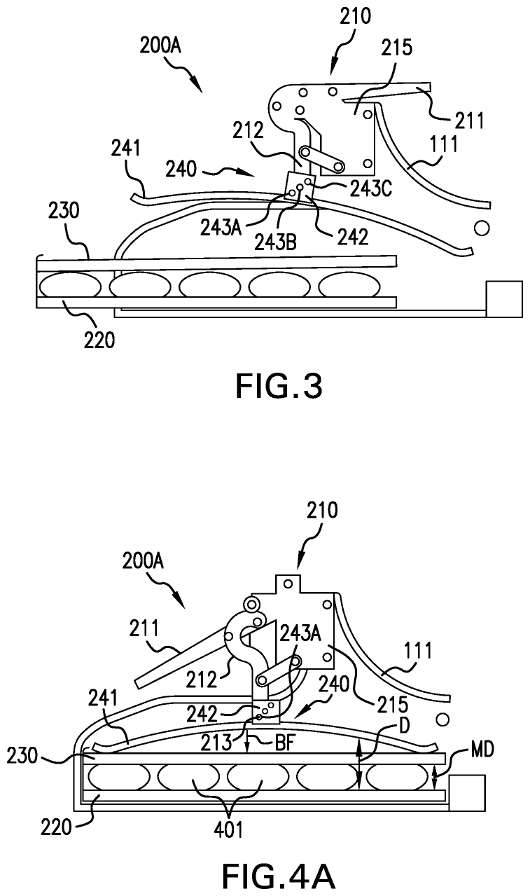

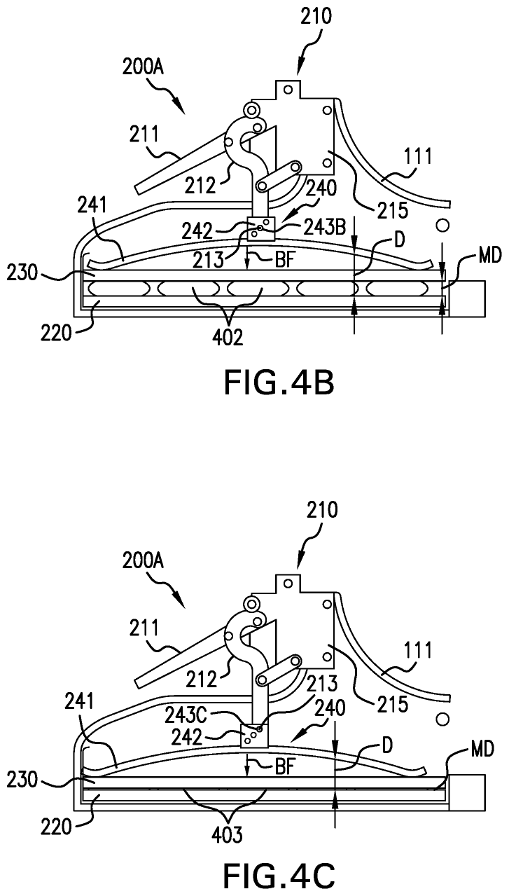

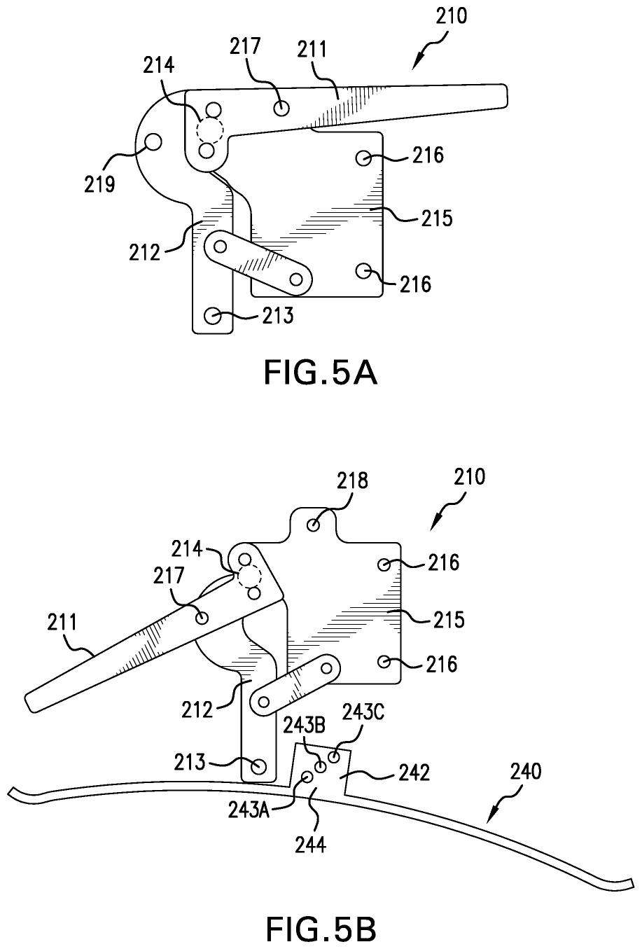

Referring specifically now to FIGS. 3-5B, one of the clamping and grate systems 200A provided according to the present invention is illustrated in greater detail. It should be appreciated that while only one of the systems 200A is illustrated in FIGS. 3-5B, all of the other systems 200B, 200C, 200D may be structured in a similar manner. The system 200A includes a clamp 210, a first grate 220, a second grate 230, and a spring assembly 240. The clamp 210, which is illustrated by itself in FIG. 5A, includes a lever 211 that is movable between an open position, which is illustrated in FIGS. 3 and 5A, and a closed position, which is illustrated in FIGS. 4A-4C as well as FIGS. 1-2. The clamp 210 also includes a clamp body 212 that includes a clamp mounting feature 213. While the clamp mounting feature 213 is illustrated as an opening, it should be appreciated that the clamp mounting feature 213 may be formed as other types of mounting features, including but not limited to a notch, a pin, etc. The clamp body 212 is configured to move responsively to the lever 211 moving between the open position and the closed position, which is best seen by comparing FIGS. 5A and 5B. The lever 211 or the clamp body 212 may, for example, include a cam 214 that causes the clamp body 212 to move responsively to the lever 211 moving, e.g., pivoting. The lever 211 and the clamp body 212 may both be coupled to a mounting bracket 215, which can mount to the sheet 111 that is coupled to the rotator 110 in order to couple the clamp 210, and thus the system 200A, to the rotator 110. The mounting bracket 215 may include, for example, one or more mounting openings 216 that each accept a respective fastener, e.g., a bolt, to couple to the sheet 111. The lever 211 may also include a detent 217 that is aligned with a respective opening 218 in the mounting bracket 215 in the open position and with a respective opening 219 of the clamp body 212 in the closed position. The detent 217 allows the lever 211 to be secured in the open or closed position to keep the lever 211 in the desired position.

The first grate 220 and the second grate 230 are spaced from each other in an adjustable manner. The second grate 230 is adjustably spaced from the first grate 220 so the second grate 230 is movable to adjust the distance between the grates 220, 230. In other words, the first grate 220 may be generally static with respect to, e.g., the mounting bracket 215 while the second grate 230 can be movable in order to adjust the distance between the grates 220, 230. The grates 220, 230 may be coupled together so respective ends of the grates 220, 230 stay parallel to one another and the grates 220, 230 are generally overlapped with one another to form a sandwich grate arrangement. The grates 220, 230 may be formed with any type of grate pattern that is suitable for holding food items, with many such grate patterns being known.

The spring assembly 240 includes a spring 241 that is configured to exert a biasing force, illustrated by arrow BF, on the second grate 230 towards the first grate 220 and also includes an adjustment block 242 that has a plurality of adjustment features, illustrated as three adjustment features 243A, 243B, 243C. The spring 241 may be a leaf spring, as illustrated, or any other element that is suitable to exert the biasing force BF on the second grate 230, e.g., a gas spring, a coil spring, etc. The spring 241 may be configured to bear on the second grate 230 when the lever 211 is in the closed position, as illustrated, or, alternatively, may act on a separate element that bears on the second grate 230. The spring 241 may also be configured to be brought out of contact with the second grate 230 when the lever 211 is in the open position, as best illustrated in FIG. 3.

As best illustrated in FIGS. 4A-4C, one of the adjustment features 243A, 243B, 243C is coupled to the clamp mounting feature 213 at any given time. The adjustment features 243A, 243B, 243C may each be coupled to the clamp mounting feature 213, for example, using a pin or in any other suitable fashion. The adjustment feature 243A is coupled to the clamp mounting feature 213 in FIG. 4A, the adjustment feature 243B is coupled to the clamp mounting feature 213 in FIG. 4B, and the adjustment feature 243C is coupled to the clamp mounting feature 213 in FIG. 4C. It should be appreciated that while the adjustment block 242 is illustrated and described as having three adjustment features 243A, 243B, 243C, the adjustment block 242 can be provided with only two adjustment features or four or more adjustment features. Further, each of the adjustment features 243A, 243B, 243C may be offset both vertically and horizontally relative from one another relative to an edge 244 of the adjustment block 242, such as a bottom edge. However, it should be appreciated that, in some embodiments, the adjustment features 243A, 243B, 243C are only offset vertically or horizontally relative to an edge of the adjustment block 242, for reasons that will become apparent further herein.

The adjustment features 243A, 243B, 243C are each configured to reversibly couple with the clamp mounting feature 213 such that a distance D between the spring 241 and the first grate 220 is controlled by which one of the adjustment features 243A, 243B, 243C is coupled with the clamp mounting feature 213 when the lever 211 is in the closed position. For example, as can be seen in FIGS. 4A and 4B, the distance D between the spring 241 and the first grate 220 is greater when the adjustment feature 243A is coupled to the clamp mounting feature 213 compared to when the adjustment feature 243B is coupled to the clamp mounting feature 213. Similarly, the distance D between the spring 241 and the first grate 220 is greater when the adjustment feature 243B is coupled to the clamp mounting feature 213 compared to when the adjustment feature 243C is coupled to the clamp mounting feature 213, as can be seen in FIGS. 4B and 4C. As can be appreciated from FIGS. 3A-3C, the first grate 220 may be supported at its bottom to be generally stationary during adjustment while the second grate 230 is movable in response to coupling the different adjustment features 243A, 243B, 243C.

Since the spring 241 exerts the biasing force BF on the second grate 230, which may be due to the spring 241 bearing on the second grate 230 or biasing an element into contact with the second grate 230, the spring 241 being a closer distance to the first grate 220 tends to bias the second grate 230 closer to the first grate 220. In other words, a minimum distance MD between the second grate 230 and the first grate 220 can be controlled by which one of the adjustment features 243A, 243B, 243C is coupled with the clamp mounting feature 213 when the lever is in the closed position. This allows differently sized food items to be held securely between the grates 220, 230. As can be seen in FIGS. 4A-4C, the adjustment feature 243A being coupled with the clamp mounting features 213 allows relatively large food items 401 to be securely held between the grates 220, 230, the adjustment feature 243B being coupled with the clamp mounting feature 213 allows medium sized food items 402 to be securely held between the grates 220, 230, and the adjustment feature 243C being coupled with the clamp mounting feature 213 allows smaller food items 403 to be securely held between the grates 220, 230. As used herein, the food items 401, 402, 403 are “securely held” between the grates 220, 230 in the sense that both of the grates 220, 230 contact the food items 401, 402, 403 simultaneously so the food items 401, 402, 403 tend to stay in place during movement of the grates 220, 230, e.g., when the rotator 110 rotates the grates 220, 230 in the cooking chamber 100. It should thus be appreciated that the adjustment features 243A, 243B, 243C allow differently sized food items to be securely held between the grates 220, 230 that can be easily and conveniently changed.

Referring back to FIGS. 1 and 2, it is illustrated that the first grate 220 and second grate 230 of each system 200A, 200B, 200C, 200D can each extend perpendicular to the rotation axis RA and parallel to one another throughout rotation of the rotator 110 (and the carried systems 200A, 200B, 200C, 200D). When a plurality of systems 200A, 200B, 200C, 200D are provided, each of the systems 200A, 200B, 200C, 200D can be spaced generally, i.e., within 10%, equidistant from one another about the rotation axis RA, i.e., the first grate 220 of the system 200A can be equidistant from the first grate 220 of the systems 200B and 200D. By having the grates 220, 230 of the systems 200A, 200B, 200C, 200D arranged and spaced in this manner, food items being cooked by the cooking device 100 can self-baste in a manner that reduces liquid loss to the heat source, e.g., ignited material 105 in the firebox 104. This is illustrated by liquid drops 250 in FIGS. 1-2, which shows that liquid tends to flow down the grates 220, 230 and onto other grates 220, 230 during rotation and only a small amount of the liquid falls into the firebox 104. Thus, this configuration can reduce the loss of liquid, such as “juice” from meat, and retain moisture in the food items during cooking so the food items do not dry out as quickly while cooking.

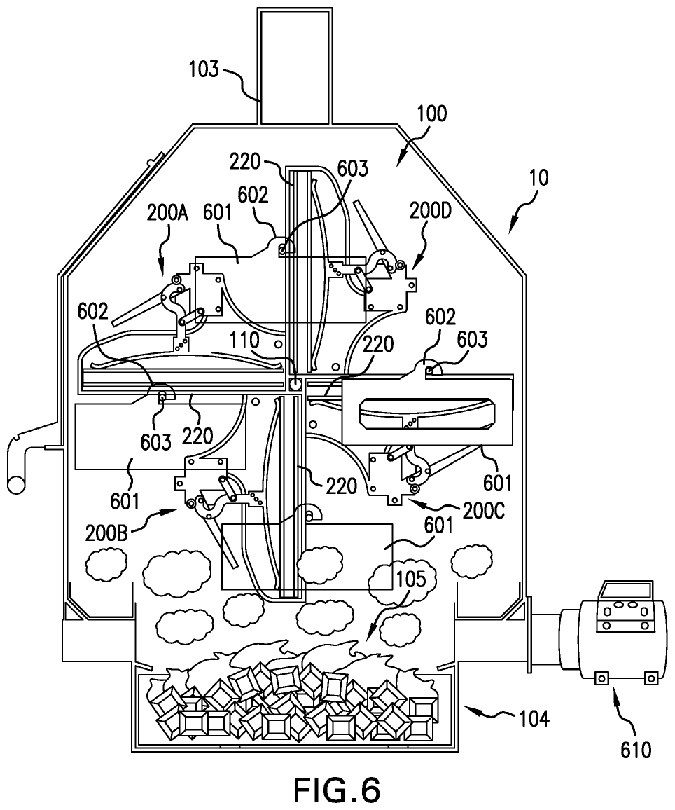

Referring now to FIG. 6, the cooking device 10 is illustrated with an optional basket 601 coupled to the rotator 110. The basket 601 may, for example, include one or more hooks 602 that couple to a pin (or strut) 603 of one of the grates 220, 230. The basket 601 may be used to cook even larger food items, such as an entire animal or large cuts of meat, and can stay upright during rotation of the rotator 110 by virtue of the hook(s) 602 being hung on the pin/strut 603. Further, FIG. 6 also illustrates that the cooking device 10 can include a blower 610 or similar device that is located adjacent to the firebox 104 in order to control airflow and heat distribution in the cooking chamber 100. The blower 610 can draw in air from outside the cooking chamber 100 and direct the air across the ignited material 105 to both provide oxygen for combustion and to disperse heat within the cooking chamber 100.

From the foregoing, it should be appreciated that the clamping and grate system 200A, 200B, 200C, 200D provided according to the present invention provides an easy and convenient way to securely hold food items of various sizes in the cooking chamber 100. Securely holding the food items can prevent loss of the food items and reduce the risk of the food items over and/or unevenly cooking and/or becoming overly dry during cooking. Further, the grates 220, 230 can be clamped and held in a manner that promotes self-basting of the food items while reducing liquid loss during cooking. Therefore, the cooking device 10 including the system(s) 200A, 200B, 200C, 200D can cook food items of various sizes in a manner that encourages even cooking while reducing liquid loss and the risk of uneven and/or over cooking.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A cooking device, comprising:
a cooking chamber; and
at least one clamping and grate system disposed inside the cooking chamber, the at least one clamping and grate system comprising:
a clamp comprising a lever that is movable between an open position and a closed position and a clamp body comprising a clamp mounting feature and configured to move responsively to the lever moving between the open position and the closed position;
a first grate;
a second grate adjustably spaced from the first grate; and
a spring assembly comprising a spring configured to exert a biasing force on the second grate towards the first grate and an adjustment block and comprising a plurality of adjustment features, one of the adjustment features being coupled to the clamp mounting feature and the plurality of adjustment features are each configured to reversibly couple with the clamp mounting feature such that a distance between the spring and the first grate is controlled by which one of the adjustment features is coupled with the clamp mounting feature when the lever is in the closed position.

2. The cooking device of claim 1, wherein the spring is configured to bear on the second grate when the lever is in the closed position.

3. The cooking device of claim 2, wherein the spring is configured to be brought out of contact with the second grate when the lever is in the open position.

4. The cooking device of claim 1, wherein the spring is a leaf spring.

5. The cooking device of claim 1, wherein the lever or the clamp body comprises a cam that causes the clamp body to move responsively to the lever moving between the open position and the closed position.

6. The cooking device of claim 1, wherein the adjustment features are each horizontally and vertically offset from one another relative to an edge of the adjustment block.

7. The cooking device of claim 1, wherein a minimum distance between the second grate and the first grate is controlled by which one of the adjustment features is coupled with the clamp mounting feature when the lever is in the closed position.

8. The cooking device of claim 1, further comprising a rotator disposed in the cooking chamber and configured to rotate within the cooking chamber, the at least one clamping and grate system being coupled to the rotator such that rotation of the rotator causes a corresponding rotation of the at least one clamping and grate system about a rotation axis.

9. The cooking device of claim 8, wherein the cooking chamber comprises a firebox and the rotator is configured to rotate the at least one clamping and grate system over the firebox.

10. The cooking device of claim 8, wherein the first grate and the second grate of the at least one clamping and grate system each extend perpendicular to the rotation axis and parallel to one another throughout rotation of the rotator.

11. The cooking device of claim 10, wherein the at least one clamping and grate system comprises a plurality of clamping and grate systems that are spaced generally equidistant from one another about the rotation axis.

12. The cooking device of claim 8, further comprising a basket coupled to the rotator such that rotation of the rotor causes a corresponding rotation of the basket about the rotation axis.

13. A clamping and grate system for a cooking device, comprising:
a clamp comprising a lever that is movable between an open position and a closed position and a clamp body comprising a clamp mounting feature and configured to move responsively to the lever moving between the open position and the closed position;
a first grate;
a second grate adjustably spaced from the first grate; and
a spring assembly comprising a spring configured to exert a biasing force on the second grate towards the first grate and an adjustment block comprising a plurality of adjustment features, one of the adjustment features being coupled to the clamp mounting feature and the plurality of adjustment features are each configured to reversibly couple with the clamp mounting feature such that a distance between the spring and the first grate is controlled by which one of the adjustment features is coupled with the clamp mounting feature when the lever is in the closed position.

14. The clamping and grate system of claim 13, wherein the spring is configured to bear on the second grate when the lever is in the closed position.

15. The clamping and grate system of claim 14, wherein the spring is configured to be brought out of contact with the second grate when the lever is in the open position.

16. The clamping and grate system of claim 13, wherein the spring is a leaf spring.

17. The clamping and grate system of claim 13, wherein the lever or the clamp body comprises a cam that causes the clamp body to move responsively to the lever moving between the open position and the closed position.

18. The clamping and grate system of claim 13, wherein the adjustment features are each horizontally and vertically offset from one another relative to an edge of the adjustment block.

19. The clamping and grate system of claim 13, wherein a minimum distance between the second grate and the first grate is controlled by which one of the adjustment features is coupled with the clamp mounting feature when the lever is in the closed position.
